(19) United States
(12) Patent Application Publication
(10) Pub. No.: US 2016/0159089 A1
(43) Pub. Date: Jun. 9, 2016

(54) LIQUID PUMP HAVING A PIEZOELECTRIC MEMBER AND INKJET APPARATUS HAVING THE SAME

(71) Applicant: TOSHIBA TEC KABUSHIKI KAISHA, Tokyo (JP)

(72) Inventor: Yoshiaki KANEKO, Mishima Shizuoka (JP)

(21) Appl. No.: 15/040,730

(22) Filed: Feb. 10, 2016

Related U.S. Application Data
(62) Division of application No. 14/840,424, filed on Aug. 31, 2015.

(30) Foreign Application Priority Data
Sep. 1, 2014 (JP) 2014-177365

(51) Int. Cl. B41J 2/045

(52) U.S. Cl. CPC B41J 2/04541; B41J 2/04563; B41J 2/04581

(57) ABSTRACT

A liquid pump includes a piezoelectric pump unit and a control unit. The piezoelectric pump unit includes an inlet, an outlet, and a chamber formed between the inlet and the outlet, and a wall of the chamber includes a piezoelectric member. The control unit is configured to apply to the piezoelectric member, a first voltage in a polarization direction of the piezoelectric member and a second voltage in a direction opposite to the polarization direction, such that the piezoelectric member is deformed. The first voltage is greater than the second voltage.

### CROSS-REFERENCE TO RELATED APPLICATION

This application is a division of U.S. patent application Ser. No. 14/840,424, filed on Aug. 31, 2015, which is based upon and claims the benefit of priority from Japanese Patent Application No. 2014-177365, filed Sep. 1, 2014, the entire contents of each of which are incorporated herein by reference.

### FIELD

Embodiments described herein relate generally to a liquid pump, in particular a liquid pump that conveys liquid using a piezoelectric member.

### BACKGROUND

Generally, an ink jet device needs to stably discharge ink. Ink discharging property usually depends on viscosity of the ink. An ink jet device of one type circulates the ink therein and heats or cools the ink to a predetermined temperature, so as to maintain the viscosity of the ink to be constant.

In the related art, a piezoelectric pump is used to convey a liquid. The piezoelectric pump includes a piezoelectric element, and a voltage is applied to the piezoelectric element to pressurize the liquid being conveyed. The piezoelectric pump is generally compact in size, light, and less expensive compared to other pumps.

A tolerable voltage applied to the piezoelectric element depends on a temperature of the liquid. When a voltage higher than the tolerable voltage is applied to the piezoelectric element, the piezoelectric element may not properly work and a pumping performance may deteriorate. Meanwhile, when a voltage much lower than the tolerable voltage is applied to the piezoelectric element, liquid conveying capacity of the piezoelectric pump decreases, and a desirable pumping performance may not be obtained.

### DESCRIPTION OF THE DRAWINGS

FIG. 1 is a front view of an ink jet apparatus according to an embodiment.

FIG. 2 is a plan view of the ink jet apparatus in FIG. 1.

FIGS. 3A and 3B schematically illustrate a portion of a nozzle in the ink jet apparatus in FIG. 1.

FIG. 4 schematically illustrates a flow path of an ink in an ink jet head of the ink jet apparatus in FIG. 1.

FIG. 5A is a perspective view of an ink jet unit of the ink jet apparatus in FIG. 1.

FIG. 5B is a perspective view in a direction opposite to the direction of FIG. 5A.

FIG. 6 is a cross-sectional view of the ink jet unit in FIG. 5A.

FIG. 7 schematically illustrates a structure of the ink jet unit in FIG. 5A.

FIG. 8 schematically illustrates a piezoelectric pump which is used in the ink jet unit in FIGS. 5A and 5B.

FIG. 9 is a cross-sectional view of the piezoelectric pump taken along ling A-A in FIG. 8.

FIG. 10 is a block diagram of the ink jet apparatus in FIG. 1.

FIG. 11 is a graph showing a relationship between a temperature and a coercive electric field of a piezoelectric element (PZT).

FIG. 12 illustrates a waveform of a voltage applied to the piezoelectric pump by a drive circuit.

FIG. 13 illustrates a waveform of a voltage applied to the piezoelectric pump by the drive circuit.

FIG. 14 is a control flow for controlling the voltage applied to the piezoelectric pump by a drive circuit.

FIG. 15 illustrates an example of a control table used in the control flow in FIG. 13.

### DETAILED DESCRIPTION

In general, according to an embodiment, a liquid pump includes a piezoelectric pump unit and a control unit. The piezoelectric pump unit includes an inlet, an outlet, and a chamber formed between the inlet and the outlet, and a wall of the chamber includes a piezoelectric member. The control unit is configured to apply to the piezoelectric member, a first voltage in a polarization direction of the piezoelectric member and a second voltage in a direction opposite to the polarization direction, such that the piezoelectric member is deformed. The first voltage is greater than the second voltage.

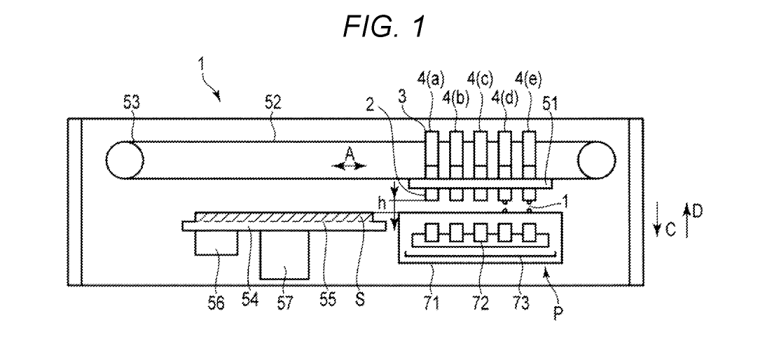

Hereinafter, a liquid circulation device for an ink jet head according to an embodiment will be described with reference to the drawings. FIG. 1 is a front view of an ink jet apparatus 1.

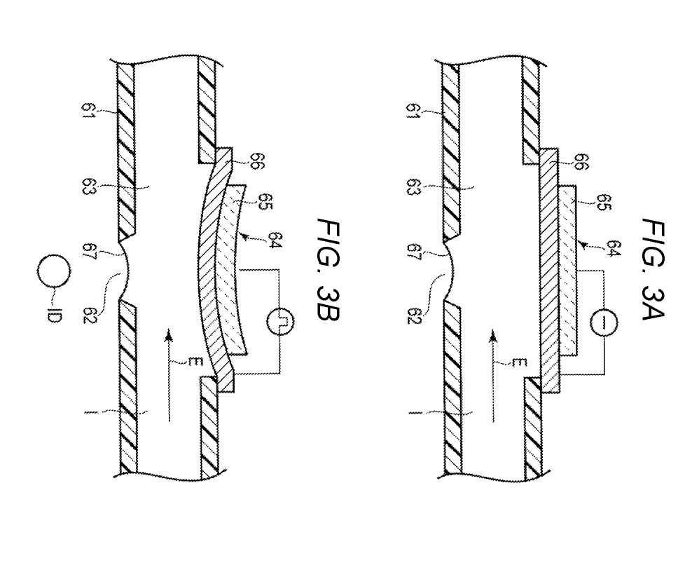

In the present embodiment, five ink jet units 4(a) to 4(e), each of which includes an ink jet head 2 and an ink circulating device 3, corresponding to the number of ink colors are arranged in parallel on a carriage 51. The ink jet head 2 contains ink I (refer to FIGS. 3A and 3B) as will be described below and discharges the ink I from nozzles 62 provided in a nozzle plate 61 in accordance with an image forming signal. The ink circulating device 3 supplies the ink I to the ink jet head 2, recovers the ink I which is not discharged from the nozzles 62, and again supplies the collected ink I to the ink jet head 2 such that the ink I is circulated, as will be described below. In the direction of gravity, the ink jet unit 4(a) includes the ink jet head 2 that discharges the ink I downward and the ink circulating device 3 in an upper portion thereof. The ink jet units 4(b) to 4(e) have the same configurations, respectively, as the ink jet unit 4(a).

The ink jet units 4(a), 4(b), 4(c), and 4(d) discharge a cyan ink, a magenta ink, a yellow ink, and a black ink, respectively. The ink jet unit 4(e) discharges a white ink, a transparent glossy ink, a special ink which produces a color when being irradiated with an infrared ray or an ultraviolet ray, or the like. The carriage 51 on which the ink jet units 4(a) to 4(e) are mounted is fixed to a transport belt 52 and the transport belt 52 is connected to a motor 53. The motor 53 is caused to normally or reversely rotate such that the carriage 51 reciprocates in an arrow A direction. The ink jet units 4(a) to 4(e) illustrated in FIG. 1 discharge the ink I in the direction of gravity (arrow C direction).

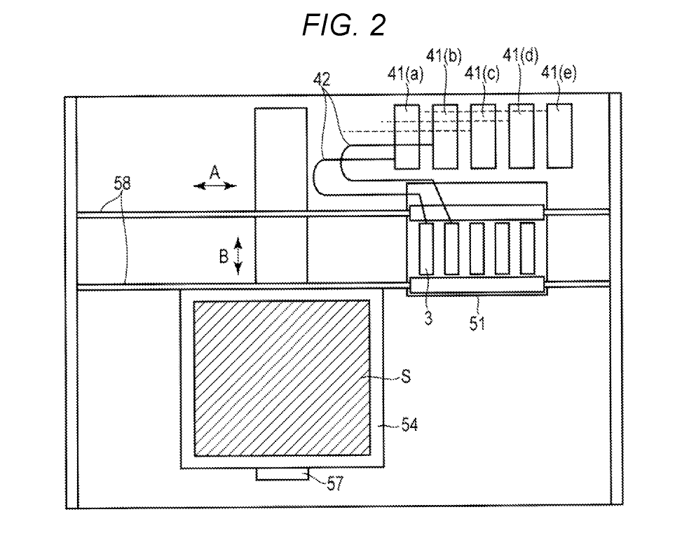

A table 54 is an airtight container and has the top surface having holes 55 each having a small diameter, such that a medium S mounted on the top surface is fixed due to negative pressure formed inside the container using an air pump 56. Examples of the medium S include paper, a film of resin or metal, a plate material, and the like. The table 54 is mounted on a sliding rail 57 and reciprocates in an arrow B direction illustrated in FIG. 2. The ink jet head 2 includes the nozzle plate 61 in which a plurality of nozzles 62 (refer to FIGS. 3A and 3B) to discharge the ink I is formed. A distance h between the nozzle plate 61 and the medium S is maintained to be constant while the ink jet head 2 reciprocates. 300 nozzles are arranged in the ink jet head 2 in a longitudinal direction thereof. The ink jet apparatus 1 causes the ink jet units 4(a) and 4(b) to reciprocate in a direction orthogonal to a transport direction of the medium S and forms an image. In other words, the 300 nozzles 62 are arranged in the longitudinal direction which is the same as the transport direction of the medium S. The ink jet apparatus 1 discharges the ink I on the medium S, having a width of the adjacent nozzles 62 and forms an image.

A maintenance unit 71 is arranged at a position out of a traveling range of the table 54 within a scanning range of the ink jet units 4(a) to 4(e) in the A direction. A position on the maintenance unit 71 which faces the ink jet head 2 is a standby position P of the ink jet head 2.

The maintenance unit 71 is a container having an opening upward and is provided so as to vertically (the arrow C and D directions in FIG. 1) travel. If the carriage 51 travels in the arrow A direction in order to form an image, the maintenance unit 71 travels to the lower side C and stands by. When an image forming operation is ended, the ink jet head 2 returns to the standby position P and the maintenance unit 71 travels to the upper side D and covers the nozzle plate 61 of the ink jet head 2. The maintenance unit 71 prevents (functions as a cap) the ink I from evaporating or dust or paper powder from being attached to the nozzle plate 61.

A rubber blade 72 that removes an ink I, dust, paper powder, or the like, attached to the nozzle plate 61 in the ink jet head 2 is included in the maintenance unit 71. If the carriage 51 travels in the arrow A direction in order to form an image, the maintenance unit 71 travels to the lower side and the blade 72 is separated from the nozzle plate 61 to the lower side C. When the blade 72 removes the ink I, dust, paper powder attached to the nozzle plate 61, the blade 72 travels to the upper side D and comes into contact with the nozzle plate 61. The maintenance unit 71 includes a mechanism which causes the blade 72 to travel in the B direction. The blade 72 may wipe a surface of the nozzle plate 61 using the mechanism which causes the blade 72 to travel in the B direction and may remove (function to wipe) the ink I, dust, paper powder.

The maintenance unit 71 includes a waste ink receiving unit 73. The waste ink receiving unit 73 stores the ink I which is forced to be discharged from the nozzles 62 during a maintenance operation and the deteriorated ink in the vicinity of the nozzles 62. The waste ink receiving unit 73 also stores a waste ink produced by wiping of the blade 72 and a waste ink produced forced to be discharged from the nozzles 62.

FIG. 2 is a plan view of the ink jet apparatus 1.

The carriage 51 on which the ink jet units 4(a) to 4(e) are mounted reciprocates in the A direction along two rails 58 by movement of the transport belt 52. The table 54 on which the medium S is mounted reciprocates in the B direction. The ink jet apparatus 1 causes the carriage 51 on which the ink jet units 4(a) to 4(e) are mounted and the table 54 on which the medium S is mounted to reciprocate in accordance with an image signal for printing and causes the ink I to be discharged from the nozzles 62 such that an image is formed on an entire surface of the medium S. The apparatus is a so-called serial ink jet apparatus.

The ink cartridge 41(a) is filled with the cyan ink and communicates with the ink circulating device 3 of the ink jet unit 4(a) through a tube 42. The ink cartridge 41(b) is filled with the magenta ink and communicates with the ink circulating device 3 of the inkjet unit 4(b) through a tube 42. Similarly, the ink cartridge 41(c) is filled with the yellow ink and communicates with the ink circulating device 3 of the ink jet unit 4(c). The ink cartridge 41(d) is filled with the black ink and communicates with the ink circulating device 3 of the inkjet unit 4(d). The ink cartridge 41(e) is filled with the white ink and communicates with the ink circulating device 3 of the ink jet unit 4(e).

Each of the ink jet units 4(a) to 4(e) mounts the ink circulating device 3 on the upper side of the ink jet head 2. The ink circulating device 3 is provided on the upper side of the ink jet head 2 such that intervals of the ink jet units 4(a) to 4(e) in an alignment direction thereof on the carriage 51 are narrowed and the carriage 51 may have a short width in the transport direction (A direction). The carriage 51 is transported in the A direction by at least a distance obtained by adding a length of twice the carriage width to the maximum width of the medium S. The narrower the width of the carriage 51 is, the shorter the transport distance is. Therefore, the ink jet apparatus 1 has a high printing speed and is reduced in size.

The ink jet unit 4 is not only applied to the ink jet apparatus 1 which uses the traveling table 54 but also to an ink jet apparatus which unwinds a paper roll, causes an ink jet unit to travel in a direction orthogonal to the paper roll, and performs printing, or to an ink jet apparatus which feeds sheets to a platen roller one by one, causes the ink jet unit to travel in a direction orthogonal to the sheet, and performs printing.

The ink jet head 2 that is applied to the ink jet apparatus 1 according to the present embodiment is described.

FIGS. 3A and 3B are cross-sectional views of a portion of the ink jet head 2 through which the ink I is discharged. In the ink jet head 2, an ink diverging portion 63 is formed on the top surface of the nozzle plate 61 having the nozzle 62 which discharges the ink I. At the ink diverging portion 63, the ink I which flows in an arrow E direction in FIGS. 3A and 3B are separated into an ink droplet ID that is discharged from the nozzle 62 and the ink I that remains in the ink jet head 2 and returns to the ink circulating device 3. The ink jet head 2 includes an actuator 64 on a surface facing the nozzle 62. The actuator 64 is a unimorph-type piezoelectric vibration plate in which piezoelectric ceramics 65 and a vibration plate 66 are stacked. As a piezoelectric ceramic material, lead zirconate titanate (PZT) is used. In the actuator 64, a gold electrode is formed on the upper and lower surfaces of the PZT and the piezoelectric ceramics 65 is formed through a polarization treatment. Then, in the actuator 64, the piezoelectric ceramics 65 is joined to the silicon nitride vibration plate 66. A meniscus 67 which is an interface between the ink I and the air is formed due to surface tension of the ink in the nozzle 62.

FIG. 3A illustrates a state in which no electric field is applied to the piezoelectric ceramics 65 and the actuator 64 is not deformed. FIG. 3B illustrates a state in which the actuator 64 is deformed and the ink droplet ID is discharged. When an electric field is applied to the piezoelectric ceramics 65 and the piezoelectric ceramics 65 is deformed. Accordingly, the ink I in the ink diverging portion 63 becomes the ink droplet ID and is discharged from the nozzle 62.

The ink I may be discharged using another configuration in which pressure is generated in the ink I instead of the actuator 64 including the piezoelectric ceramics 65 and the vibration plate 66 described above. For example, a diaphragm may be deformed using static electricity such that pressure is applied to an ink. Alternatively, a heater may heat an ink and the ink may be discharged in accordance with pressure generated when air bubbles are formed in the ink.

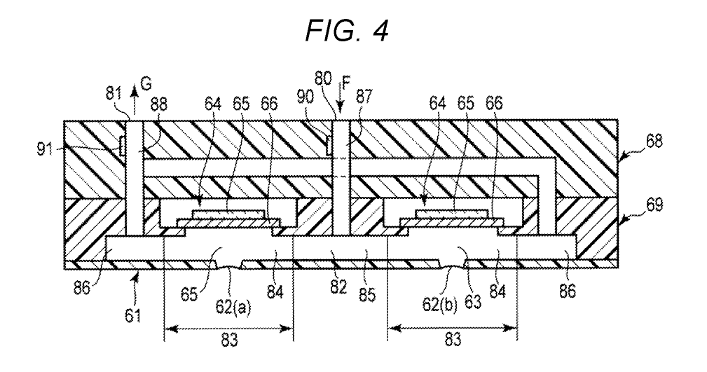

With reference to FIG. 4, flow of the ink I inside the ink jet head 2 that has a portion which discharges the ink described in FIGS. 3A and 3B is described.

The ink jet head 2 includes the nozzle plate 61, a substrate 69 that has the actuator 64 illustrated in FIG. 3, a manifold 68, an ink supply port 80 which causes the ink I to flow into a flow path, an ink ejecting port 81 through which the ink I is recovered to the ink circulating device 3 from the ink jet head 2.

The nozzle plate 61 includes a first nozzle row that has a plurality of nozzles 62(a) which is aligned in a depth direction of FIG. 4 and a second nozzle row that has a plurality of nozzles 62(b) which are aligned in a depth direction of FIG. 4. As described above, the ink I is discharged through the respective nozzles 62 (62(a) and 62(b)). In other words, the ink jet head 2 is long in the depth direction from the front of the paper surface and the nozzles 62(a) and 62(b) are arranged in a longitudinal direction thereof. The plurality of nozzles 62(a) and 62(b) is arranged in the B direction (refer to FIG. 2) and aligned in a direction orthogonal to the traveling direction of the carriage 51.

The substrate 69 includes a flow path 82 in which the ink I flows. The flow path 82 is formed by adhesion of the nozzle plate 61 to the substrate 69. The actuator 64 that generates the pressure which causes the ink I to be discharged faces the flow path 82 and is provided corresponding to each nozzle 62. The pressure generated in the ink I in the flow path 82 by the actuator 64 is concentrated on the nozzle 62 by a boundary wall 83 provided between adjacent nozzles 62.

An ink pressurizing chamber 84 is formed in the flow path 82 surrounded by the nozzle plate 61, the actuator 64, and the boundary wall 83. A plurality of ink pressurizing chambers 84 is provided corresponding to the nozzles 62(a) and 62(b) of the first nozzle row and the second nozzle row. The first nozzle row and the second nozzle row each have 300 nozzles. The ink pressurizing chamber 84 has a configuration in which the ink I flows into the chamber through one end thereof, passes through the ink diverging portion 63, and flows out from the other end thereof. A portion of the ink I in the ink diverging portion 63 inside the ink pressurizing chamber 84 is discharged from the corresponding nozzle 62. The ink I remaining in the flow path 82 flows out from the other end.

The flow path 82 between the plurality of ink pressurizing chambers 84 formed corresponding to the nozzles 62(a) in the first nozzle row and the plurality of ink pressurizing chambers 84 formed corresponding to the nozzles 62(b) in the second nozzle row forms a common ink chamber 85. The common ink chamber 85 is connected to inlets on one side of the ink pressurizing chambers 84 and configured to supply the ink I to all of the ink pressurizing chambers 84.

Ink I that flows out from ends on the other side of the plurality of ink pressurizing chambers 84 corresponding to the first nozzle row and the plurality of ink pressurizing chambers 84 corresponding to the second nozzle row flows into common ink chambers 86 which lead to the first and second nozzle rows, respectively. The common ink chamber 86 becomes a portion of the flow path provided in the substrate 69.

The manifold 68 is attached to the substrate 69, such that the ink I is supplied to the flow path 82. The manifold 68 includes the ink supply port 80 which allows the ink I to flow into the flow path in an arrow F direction and an ink distributing passage 87 through which the ink supply port 80 communicates with the common ink chamber 85. A first intra-head temperature sensor 90 on the upstream side is attached to the ink distributing passage 87 so as to detect a temperature of an ink supplied to the ink jet head 2.

In addition, the manifold 68 includes an ink ejecting port 81 to eject the ink I in an arrow G direction and an ink reverse passage 88 through which the two common ink chambers 86 communicate with the ink ejecting port 81. A second intra-head temperature sensor 91 on the downstream side is attached to the ink reverse passage 88 so as to detect a temperature of the ink ejected from the ink jet head 2.

The first intra-head temperature sensor 90 and the second intra-head temperature sensor 91 detect a temperature of the ink supplied into the ink jet head 2 or a temperature of the ink ejected from the ink jet head 2. Flow rate of the ink I in the ink circulating device 3 is controlled based on a temperature of the ink I in the ink jet head 2, so that an appropriate viscosity of the ink is maintained.

The ink I travels inside the ink jet head 2 through the ink supply port 80, the ink distributing passage 87, the common ink chamber 85, the ink pressurizing chamber 84, the common ink chamber 86, the ink reverse passage 88, and the ink ejecting port 81, in this order. A portion of the ink I is discharged from the nozzles 62 in accordance with an image signal, and remaining ink I returns to the ink circulating device 3 from the ink ejecting port 81.

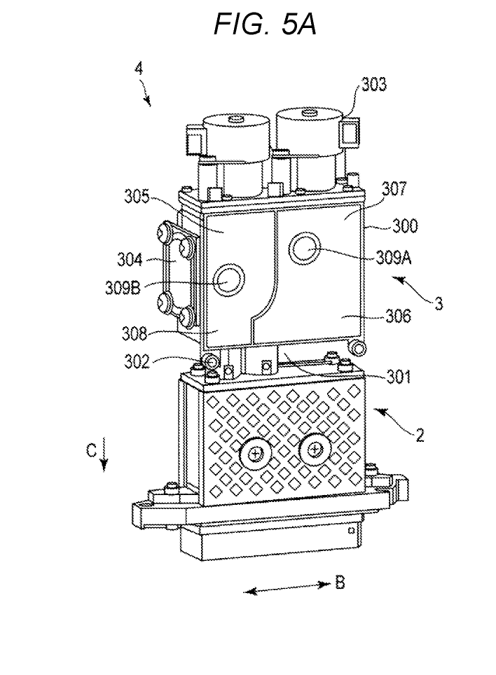

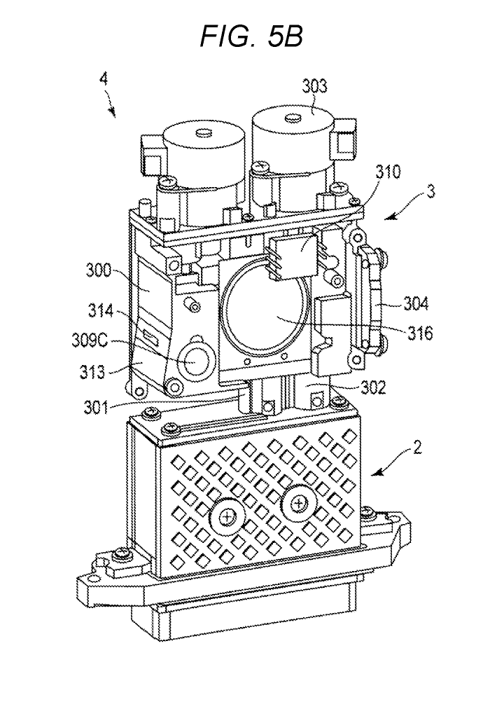

With reference to FIG. 5A to FIG. 10, the ink circulating device 3 is described.

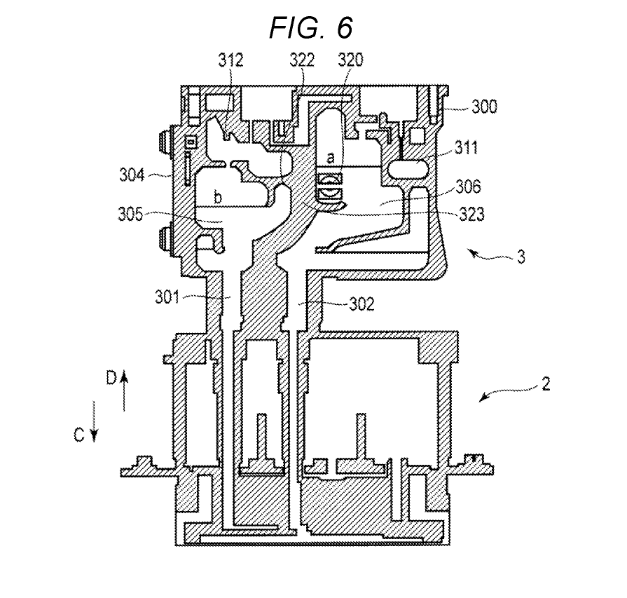

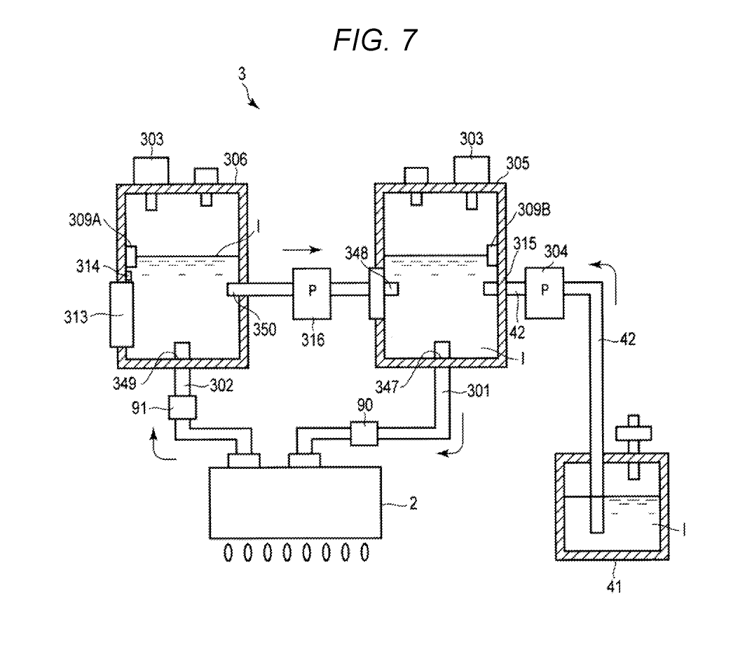

FIGS. 5A and 5B illustrate the ink jet unit 4 in which the ink circulating device 3 is arranged in the upper side of the ink jet head 2 and the ink circulating device 3 and the ink jet head 2 are integrally formed. FIG. 6 is a cross-sectional view of the ink jet head 2 and the ink circulating device 3. FIG. 7 schematically illustrates flow of the ink I in the inkjet unit 4 according to the embodiment.

The ink circulating device 3 includes an ink casing 300, an ink supply tube 301 that supplies the ink I to the ink jet head 2, an ink returning tube 302 that returns the ink I from the ink jet head 2, a pressure adjustor 303 that adjusts the pressure inside the ink casing 300 so as to maintain an appropriate ink pressure in the nozzles 62 of the inkjet head 2. The ink circulating device 3 delivers the ink I downward (arrow C which is the direction of gravity) through the ink supply tube 301, and the ink jet head 2 discharges the ink I further downward.

The ink circulating device 3 includes an ink supply pump 304 that feeds an amount of an ink I consumed in printing, an maintenance operation, or the like, to the ink casing 300, on an outside wall of the ink casing 300. The ink circulating device 3 includes a supply-side ink chamber 305, which is a first tank, and a collection-side ink chamber 306, which is a second tank, such that the ink I is stored inside the ink casing 300. The collection-side ink chamber 306 is closed by a first plate 307, and the supply-side ink chamber 305 is closed by a second plate 308. The ink supply pump 304 supplies the ink I to the supply-side ink chamber 305.

As illustrated in FIG. 7, the supply-side ink chamber 305 includes an ink feeding port 315 to feed the ink I from the ink cartridge 41, an outlet 347 to eject the fed ink I to the ink jet head 2 through the ink supply tube 301, and an inlet 348 to recover the ink I from the collection-side ink chamber 306.

As illustrated in FIG. 7, the collection-side ink chamber 306 includes an inlet 349 for collecting the ink I not ejected from the ink jet head 2 as the ink droplet ID through the ink returning tube 302 and an outlet 350 for recovering the ink I stored in the collection-side ink chamber 306 and supplying to the supply-side ink chamber 305.

The ink casing 300 has ink level measurement sensors 309A, 309B, and 309C for measuring how much the collection-side ink chamber 306 and the supply-side ink chamber 305 are filled with the ink I.

The ink level measurement sensor 309A measures an amount of an ink in the collection-side ink chamber 306 and is attached to the first plate 307 that closes the ink casing 300. The ink level measurement sensor 309B measures an amount of an ink in the supply-side ink chamber 305 and is attached to the second plate 308. The ink level measurement sensor 309C is formed of a piezoelectric vibration plate that adheres to the ink casing 300 (refer to FIG. 5B).

To be brief, an ink level measurement method of the ink level measurement sensors 309A, 309B, and 309C is performed by the following method. First, the piezoelectric vibration plate of the ink level measurement sensor 309C is caused to vibrate with an AC voltage such that the ink I in the ink casing 300 vibrates. Next, the ink level measurement sensors 309A and 309B detect vibration of the ink I which is propagated in the ink casing 300 by the ink level measurement sensor 309C. An ink level is measured from the vibration of the ink I which is propagated in the ink casing 300 by the ink level measurement sensor 309C.

Air chambers are formed on above an ink surface a of the ink I in the collection-side ink chamber 306 and above an ink surface b of the ink I in the supply-side ink chamber 305 in FIG. 6. The ink circulating device 3 includes a pressure sensor 310 for detecting air pressure of the air in the supply-side ink chamber 305 and the collection-side ink chamber 306 (refer to FIG. 5B). The pressure sensor 310 includes two pressure detecting ports in one chip and detects pressures of the air in two ink chambers (the supply-side ink chamber 305 and the collection-side ink chamber 306) in the ink casing 300.

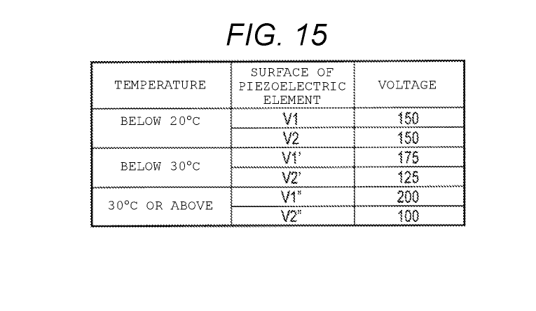

A detection portion of the pressure sensor 310 communicates with an air section of the collection-side ink chamber 306 through a communication hole 311, communicates with an air section of the supply-side ink chamber 305 through a communication hole 312, and measures the pressures of the air in the two ink chambers. The pressure sensor 310 outputs air pressures in the supply-side ink chamber 305 and the collection-side ink chamber 306 as electrical signals, respectively, and is connected to a control board 500 (refer to FIG. 15).

In order to adjust an ink viscosity of the ink I in the ink casing 300, a heater 313 for heating the ink I is provided on the outside of the collection-side ink chamber 306. The heater 313 adheres to the ink casing 300 with an adhesive having high thermal conductivity. An ink temperature sensor 314 is attached in the vicinity of the heater 313 of the collection-side ink chamber 306. The ink temperature sensor 314 and the heater 313 are connected to the control board 500 and are controlled such that the ink has a desired ink viscosity during printing.

Hereinafter, respective configurations will be described in detail.

The ink supply pump 304 illustrated in FIGS. 5A and 5B, FIG. 6, and FIG. 7 is attached to an outer wall of the ink circulating device 3 of the ink jet unit 4. The tube 42 to deliver the ink I from the ink cartridge 41 to the ink circulating device 3 is connected to the ink feeding port 315. The ink feeding port 315 is an inlet through which the ink I flows to the ink supply pump 304 from the ink cartridge 41. The ink supply pump 304 supplies the ink I to the supply-side ink chamber 305 in the ink circulating device 3 from the ink feeding port 315.

The ink supply pump 304 is a piezoelectric pump. In the ink supply pump 304, the piezoelectric vibration plate formed by bonding the piezoelectric element to the metal plate is deformed, whereby a volume inside the pump is cyclically changed such that the ink I is transported.

As illustrated in FIG. 5B, an ink circulating pump 316 is provided on a surface opposite to the surface of the first plate 307 that covers the collection-side ink chamber 306 and the surface of the second plate 308 that covers the supply-side ink chamber 305. A microcomputer 510 (hereinafter, also referred to as a control unit 510) that functions as a control unit is held in the ink jet unit 4 so as to cover the ink circulating pump 316. The control unit 510 controls the ink circulating pump 316, the ink supply pump 304, the pressure adjustor 303, or the like.

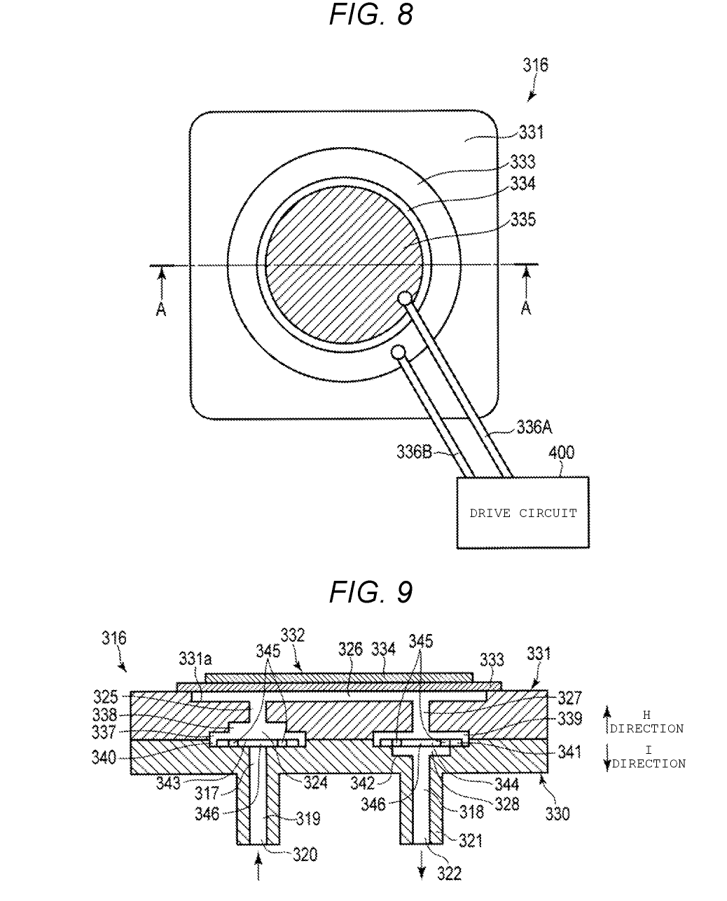

The ink circulating pump 316 includes an inlet 317 to recover the ink I and a liquid delivery port 318 to deliver the ink as illustrated in FIG. 9. The ink circulating pump 316 performs suction of the ink I from a suction hole 320 of the collection-side ink chamber 306 through a first ink communicating path 319 and the inlet 317 and causes the ink I to flow into the supply-side ink chamber 305 from an ejection hole 322 through the liquid delivery port 318 and a second ink communicating path 321 (refer to FIG. 7 and FIG. 9). The airtight supply-side ink chamber 305 has an increased amount of the ink by driving of the ink circulating pump 316 and has high internal pressure. The ink I flows into the ink jet head 2 through the ink supply tube 301 (refer to FIG. 7).

FIG. 6 illustrates the inside of the ink circulating device 3.

The ink casing 300 includes the supply-side ink chamber 305 to supply the ink I to the ink jet head 2 through the ink supply tube 301 and the collection-side ink chamber 306 to which the ink I is recovered from the ink jet head 2 through the ink returning tube 302. The ink casing 300 is formed of aluminum. The supply-side ink chamber 305 is formed by fixing the first plate 307 made of a resin to a frame that forms the supply-side ink chamber using an adhesive. Similarly, the collection-side ink chamber 306 is formed by fixing the second plate 308 made of a resin to a frame that forms the collection-side ink chamber 306 using an adhesive. As a material of the first plate 307 and the second plate 308, a polyimide resin is used.

The ink casing 300 may be formed of metal or resin in addition to aluminum if the material does not alter the properties of the ink I. As the metal, stainless steel, brass, or the like may be used. As the resin, acrylonitrile butadiene styrene (ABS), epoxy resin, polycarbonate, or the like may be used. In addition, the first plate 307 and the second plate 308 may be formed of polyethylene terephthalate (PET), polyamide, aluminum, stainless steel, brass, or the like, instead of the polyimide resin.

The collection-side ink chamber 306 and the supply-side ink chamber 305 are integrally formed and share a common wall 323 therebetween. An arrangement direction of the collection-side ink chamber 306 and the supply-side ink chamber 305 is the same as a nozzle alignment direction (longitudinal direction (B direction) of the ink jet head 2) of the ink jet head 2. That is, the arrangement direction of the collection-side ink chamber 306 and the supply-side ink chamber 305 provided on the upper side of the ink jet head 2 is substantially orthogonal to the scanning direction of the carriage 51.

It is advantageous, in the following points, that the collection-side ink chamber 306 and the supply-side ink chamber 305 are arranged in the direction substantially orthogonal to the scanning direction of the carriage 51. First, when the carriage 51 starts or stops scanning, the carriage 51 accelerates or decelerates. At the time of acceleration or deceleration of the carriage 51, the ink surfaces (ink surface a and ink surface b) in the collection-side ink chamber 306 and the supply-side ink chamber 305 vibrate. The ink surface a and the ink surface b substantially equally vibrate because the collection-side ink chamber 306 and the supply-side ink chamber 305 are arranged in the direction substantially orthogonal to the scanning direction. Since the ink surface a and the ink surface b have a small difference in the vibration from each other, a meniscus 67 of the ink jet head 2 positioned between the collection-side ink chamber 306 and the supply-side ink chamber 305 does not fluctuate greatly. Therefore, the ink jet head 2 may stably discharge the ink I from the nozzle 62 even at the time of the acceleration or deceleration of the carriage 51 when the fluctuation of the meniscus 67 is small.

Second, in the ink jet apparatus 1, five ink jet units 4 of the ink jet units 4(a) to 4(e) are aligned in the scanning direction of the carriage 51. The collection-side ink chamber 306 and the supply-side ink chamber 305 are arranged in the direction substantially orthogonal to the scanning direction of the carriage 51, such that the width of the carriage 51 of the ink jet unit 4 in the scanning direction may become narrower and miniaturization of the ink jet apparatus 1 may be achieved compared to an ink jet apparatus in which the collection-side ink chamber 306 and the supply-side ink chamber 305 are arranged in the same direction as the scanning direction of the carriage 51.

The ink casing 300 includes the suction hole 320 and the ejection hole 322. The suction hole 320 guides the ink I into the outlet 350 through which the ink I in the collection-side ink chamber 306 is conveyed by the ink circulating pump 316. The ejection hole 322 communicates with the inlet 348 of the supply-side ink chamber 305 and guides the ink I to the supply-side ink chamber 305 (refer to FIG. 6 and FIG. 7). The collection-side ink chamber 306 and the supply-side ink chamber 305 are adjacent across the common wall 323 (refer to FIG. 6). The ink circulating pump 316 is provided to extend between the adjacent collection-side ink chamber 306 and supply-side ink chamber 305 (refer to FIG. 5 and FIG. 7). As illustrated in FIG. 9, the inlet 317 of the ink circulating pump 316 and the suction hole 320 of the ink casing 300 are connected through the first ink communicating path 319. In addition, the liquid delivery port 318 of the ink circulating pump 316 and the ejection hole 322 of the ink casing 300 are connected through the second ink communicating path 321 (refer to FIG. 9). The first ink communicating path 319 and the second ink communicating path 321 are provided to be perpendicular to a plate surface of the flat plate-shaped ink circulating pump 316. The second ink communicating path 321 is substantially horizontally connected to the collection-side ink chamber 306. The ink I is transported to the supply-side ink chamber 305 through the second ink communicating path 321 from the ink circulating pump 316.

In the present embodiment, the first ink communicating path 319 and the second ink communicating path 321 are provided in the ink circulating pump 316. Alternatively, the first ink communicating path 319 and the second ink communicating path 321 may be provided in the ink casing 300. The first ink communicating path 319 and the second ink communicating path 321 areas short as possible, whereby the ink circulating device 3 may have a small size.

The ink circulating pump 316 is the same piezoelectric pump as the ink supply pump 304 described above. A configuration of the piezoelectric pump provided in the ink supply pump 304 and the ink circulating pump 316 is described in detail. Since the ink supply pump 304 and the ink circulating pump 316 have the same configuration, the ink circulating pump 316 is described as an example.

FIG. 8 illustrates the piezoelectric pump of the ink circulating pump 316 (hereinafter, simply referred to as the piezoelectric pump) connected to a drive power source according to the present embodiment. FIG. 9 is a cross-sectional view of the piezoelectric pump taken along line A-A in FIG. 8.

As illustrated in FIG. 9, the ink circulating pump 316 includes a lower housing 330, an upper housing 331, and a piezoelectric actuator 332. When the lower housing 330 and the upper housing 331 are assembled, a suction chamber 324 and a liquid delivering chamber 328 are formed.

An ink suction section of the ink circulating pump 316 has the inlet 317 into which the ink I flows, the suction chamber 324 (first liquid chamber) that communicates with the inlet 317, and a first communication hole 325 that communicates with the suction chamber 324. A first check valve 343 is provided between the inlet 317 and the suction chamber 324. The first communication hole 325 communicates with a pump chamber 326 (third liquid chamber). The pump chamber 326 (third liquid chamber) communicates with the liquid delivering chamber 328 (second liquid chamber) through a second communication hole 327. The liquid delivering chamber 328 (second liquid chamber) communicates with the liquid delivery port 318 through a second check valve 344.

The ink circulating pump 316 causes a volume of the pump chamber 326 to expand or contract to deliver the ink I. When the pump chamber 326 expands, the ink I is sucked into the pump chamber 326 through the first liquid chamber 324 from the inlet 317. When the pump chamber 326 contracts, the ink I is delivered to the liquid delivering chamber 328 (second liquid chamber) through the second communication hole 327 from the pump chamber 326. The ink I is transported to the outside of the ink circulating pump 316 through the liquid delivery port 318 from the liquid delivering chamber 328. The flow of the ink I to the liquid delivery port 318 from the inlet 317 of the ink circulating pump 316 is regulated in one direction by the first check valve 343 and the second check valve 344.

As illustrated in FIG. 8, the piezoelectric actuator 332 includes a metal plate 333, piezoelectric ceramics 334 fixed on the metal plate 333, and silver paste 335 applied on the piezoelectric ceramics 334 which functions as an electrode. The metal plate 333 is, for example, stainless steel having a diameter of 30 mm and a thickness of 0.2 mm. A surface of the metal plate 333 facing the pump chamber 326 is formed of a coating film of a resin. The coating film is provided so as to prevent a liquid from contacting the metal plate 333. The piezoelectric ceramics 334 is, for example, lead zirconate titanate (PZT) having a diameter of 25 mm and a thickness of 0.25 mm. The piezoelectric ceramics 334 is polarized in a thickness direction thereof, contracts in a plane direction thereof when an electric field is applied in the thickness direction, and the pump chamber 326 expands or contracts. The electrode (silver paste) 335 on the piezoelectric ceramics 334 and the metal plate 333 are connected to a drive circuit 400 through wires 336A and 336B.

In an operation of delivery of the ink I (first operation), the drive circuit 400 drives the piezoelectric actuator 332 at a frequency of 100 Hz and an AC voltage of 100 V. The piezoelectric actuator 332 causes the pump chamber 326 to expand or contract such that the ink I is transported.

As a material of the metal plate 333, nickel, brass, silver, gold, copper, or the like may be used instead of stainless steel. As a material of the piezoelectric ceramics 334, PTO (PbTiO3: lead titanate), PMNT (Pb(Mg1/3Nb2/3)O3-PbTiO3), PZNT (Pb(Zn1/3Nb2/3)O3-PbTiO3), ZnO, AlN, or the like may be used instead of PZT. The piezoelectric actuator 332 may operate at a voltage in a range of AC 1 mV to AC 200 V and a frequency in a range of 1 mHz to 200 Hz. The drive voltage and the drive frequency may be appropriately adjusted in accordance with the viscosity of the ink I and a flow rate of the ink I.

The upper housing 331 is formed of, for example, polyphenylene sulfide (PPS) resin having a diameter of 40 mm and a thickness of 3 mm and has a concave portion 331a with a diameter of 30 mm and a depth of 0.1 mm on the upper section thereof (refer to FIG. 9). The pump chamber 326 is formed by fixing the metal plate 333 of the piezoelectric actuator 332 to the upper housing 331 using an adhesive, such that the metal plate 333 covers the concave portion 331a.

A first rectangular concave section 337 for forming the suction chamber 324 and a second rectangular concave section 338 that has the same center as the first concave section 337 and has a plane area smaller than the first concave section 337 are arranged in a stepwise manner, on a side of the inlet 317, i.e., a surface of the upper housing 331opposite to the concave portion 331a.

The suction chamber 324 communicates with the pump chamber 326 through the first communication hole 325 that has the same center as the second concave section 338 and penetrates the upper housing 331.

A third rectangular concave section 339 for forming the liquid delivering chamber 328 is formed on a side of the liquid delivery port 318, i.e., a surface of the upper housing 331 opposite to the concave portion 331a. The liquid delivering chamber 328 communicates with the pump chamber 326 through the second communication hole 327 that has the same center as the third concave section 339 and penetrates the upper housing 331.

The lower housing 330 is formed of, for example, polyphenylene sulfide (PPS) resin having a diameter of 40 mm and a thickness of 3 mm. A fourth rectangular concave section 340 for forming the suction chamber 324 that has the same center as the first concave section 337 is provided in a surface of the lower housing 330 facing the upper housing 331. The suction chamber 324 is formed by the first concave section 337, the second concave section 338, and the fourth concave section 340. The fourth concave section 340 communicates with the first ink communicating path 319 that has the same center as the first communication hole 325. The ink I is sucked into the suction chamber 324 through the first ink communicating path 319.

Further, a fifth rectangular concave section 341 for forming the liquid delivering chamber 328 is formed on the same surface as the fourth concave section 340 of the lower housing 330. The fifth rectangular concave section 341 for forming the liquid delivering chamber 328 and a sixth rectangular concave section 342 that has the same center as the fifth concave section 341 and has a plane area smaller than the fifth concave section 341 are arranged in a stepwise. The sixth concave section 342 has the same center as the second communication hole 327 and communicates with the second ink communicating path 321.

The suction chamber 324 has the first check valve 343. The first check valve 343 is formed of polyimide and is rectangular. The first check valve 343 has a rectangular shape slightly smaller than the suction chamber 324. A hole (slit) 345 is formed in the first check valve 343 such that a polyimide check valve circular portion 346 remains at the center of the first check valve 343.

The first check valve 343 vertically moves in a height direction (L or H direction) as the ink I flows into the first communication hole 325 from the inlet 317 (refer to FIG. 9). The ink I flows toward the first communication hole 325 from the inlet 317 and flowing of the ink I in the reverse direction thereto is regulated.

In addition, the liquid delivering chamber 328 includes a second check valve 344 with the same configuration as the first check valve 343. The liquid delivering chamber 328 has a configuration in which the shape and size are the same as the suction chamber 324 and a flowing direction of the ink I is reversed. The second check valve 344 vertically moves in the height direction (H direction or L direction) as the ink I flows into the liquid delivery port 318 from the second communication hole 327 in the liquid delivering chamber 328. The ink I flows toward the liquid delivery port 318 from the second communication hole 327, and flowing of the ink I in the reverse direction thereto is regulated.

Next, an operation performed when the ink circulating pump 316 sucks the ink I from the inlet 317 is described.

A drive voltage is applied to the piezoelectric actuator 332 in response to a drive signal from the drive circuit 400 and the piezoelectric actuator 332 extends to the outer side such that the pump chamber 326 expands. The internal pressure of the pump chamber 326 is decreased in accordance with the expansion of the volume of the pump chamber, which causes the ink I to flow into the suction chamber 324 through the first ink communicating path 319. The first check valve 343 is raised in the H direction due to the flowing-in ink I. The raised first check valve 343 in the H direction stays in the second concave section 338. The ink I flows into the pump chamber 326 through the hole 345 of the first check valve 343. At this time, the internal pressure of the pump chamber 326 is decreased in accordance with the expansion of the volume of the pump chamber, whereby the second check valve 344 moves to the third concave section 339 and blocks the second communication hole 327.

Next, an operation performed when the ink circulating pump 316 ejects the ink I from the liquid delivery port 318 will be described.

A drive voltage is applied to the piezoelectric actuator 332 in response to a drive signal from the drive circuit 400 and the piezoelectric actuator 332 contracts to the inner side, such that the volume of the pump chamber 326 is decreased. The internal pressure in the pump chamber 326 is increased in accordance with the decrease of the volume of the pump chamber 326, which causes the ink I to flow into the liquid delivering chamber 328 from the second communication hole 327. The second check valve 344 moves in the L direction in accordance with the flowing-in ink I and stays in the sixth concave section 342. The ink I is delivered to the second ink communicating path 321 through the hole 345 of the second check valve 344. At this time, the internal pressure of the pump chamber 326 is increased in accordance with the decrease of the volume of the pump chamber 326, whereby the first check valve 343 moves to the fourth concave section 340 and blocks the inlet 317.

The above operation is repeated, whereby the ink I flows in a direction from the suction chamber 324 to the liquid delivering chamber 328.

When the ink circulating pump 316 having the above configuration is operated, the ink I is sucked in through the suction hole 320 from the collection-side ink chamber 306 and is transported to the supply-side ink chamber 305 through the ink circulating pump 316 and the ejection hole 322 (refer to FIG. 7). The flow rate of the ink is increased and the internal pressure becomes higher in the airtight supply-side ink chamber 305 such that the ink I flows into the ink jet head 2 through the ink supply tube 301 (refer to FIG. 7).

According to the present embodiment, as a material of the first check valve 343 and the second check valve 344, polyimide is used. The reason why the polyimide is used is that the polyimide has a resistance to various ink materials such as a water-based ink, an oil-based ink, an ink or a UV ink of volatile solvent, which are discharged from the inkjet apparatus. In addition, the material of the first check valve 343 and the second check valve 344 has stiffness in which Young's modulus is 1×107 [Pa] or higher. The check valve having the stiffness in which Young's modulus is 1×107 [Pa] or higher may transport the ink I through the holes 345 in the suction chamber 324 and the liquid delivering chamber 328, and may close or open the inlet 317, the liquid delivery port 318, the first communication hole 325, and the second communication hole 327. As the material of the first check valve 343 and the second check valve 344, a resin or metal having high ink resistance, for example, polyethylene terephthalate (PET), ultrahigh molecular weight polyethylene (PE), polypropylene (PP), polyphenylene sulfide (PPS), polyether ether ketone (PEEK), tetrafluoroethylene-perfluoroalkyl vinyl ether copolymer (PFA), tetrafluoroethylene-hexafluoropropylene copolymer (FEP), tetrafluoroethylene-ethylene copolymer (ETFE), polytetrafluoroethylene (PTFE), aluminum, stainless steel, nickel, or the like may be used. The materials of the first check valve 343 and the second check valve 344 are not limited to the same material, but may be selected from the above resins or metals, and the selected one may be appropriately used.

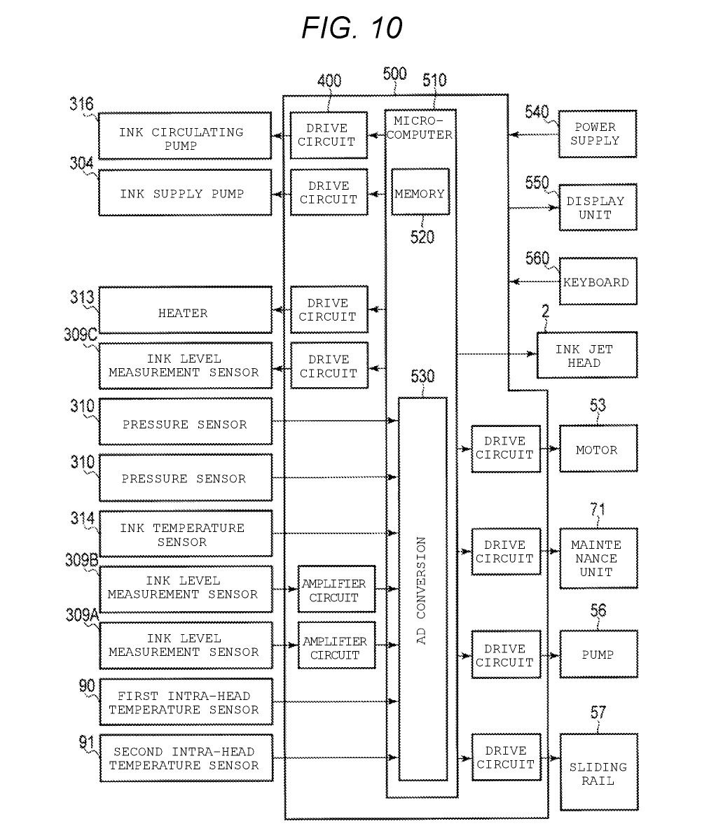

FIG. 10 is a block diagram of the control board 500 that controls the operation of the ink jet apparatus 1. A power supply 540, a display unit 550 that displays a state of the ink jet apparatus 1, and a keyboard 560 as an input device are connected to the control board 500. The control board 500 includes the microcomputer 510 that controls the operation, a memory 520 in which a program is stored, the pressure sensor 310 or the ink temperature sensor 314, the first intra-head temperature sensor 90, and an AD convertor 530 that receives an output voltage of the second intra-head temperature sensor 91. Further, the control board 500 includes a plurality of drive circuits 400 and controls the motor 53 that causes the ink jet unit 4 to travel relative to the medium S, the sliding rail 57, the ink circulating pump 316, the ink supply pump 304, the air pump 56, the heater 313, or the like.

If the ink jet apparatus 1 is caused to perform the first printing operation, the ink circulating device 3 and the ink jet head 2 need to be filled with the ink I from the ink cartridge 41. That is, the ink circulating device 3 and the ink jet head 2 of the ink jet unit 4(a) are filled with the cyan ink from the ink cartridge 41(a). Similarly, the ink jet units 4(b) to 4(e) are filled with the magenta ink, the yellow ink, the black ink, and the white ink, respectively, from the ink cartridges 41(b) to 41(e). The control unit 510 operates in the following order when an initial filling operation is instructed from the keyboard 560.

The control unit 510 causes the ink jet unit 4 to return to the standby position and causes the maintenance unit 71 to be raised such that the nozzle plate 61 is covered. The control unit 510 drives the ink supply pump 304 and causes the ink I to be delivered to the supply-side ink chamber 305 of the ink casing 300 from the ink cartridge 41 together with the air in the tube 42. When the ink level measurement sensor 309B of the supply-side ink chamber 305 detects that the ink I flows into the ejection hole 322, the control unit 510 starts the adjustment of the internal pressure of the ink casing 300 using the pressure adjustor 303 and drives the ink circulating pump 316 for a predetermined time. The ink I is delivered to the supply-side ink chamber 305 through the ink circulating pump 316 from the collection-side ink chamber 306. The control unit 510 performs liquid level detection of the collection-side ink chamber 306 and the supply-side ink chamber 305, using the ink level measurement sensors 309A and 309B. If the ink I reaches the suction hole 320 and the ejection hole 322 of the ink circulating pump 316, the control unit 510 finishes the filling of the ink I.

If an amount of the ink of the collection-side ink chamber 306 is insufficient, the control unit 510 drives the ink supply pump 304 and delivers the ink I to the supply-side ink chamber 305 of the ink casing 300 from the ink cartridge 41. When the ink level measurement sensor 309B detects that the ink I reaches the suction hole 320, the control unit 510 starts the adjustment of the internal pressure of the ink casing 300 using the pressure adjustor 303 and drives the ink circulating pump 316 for a predetermined time. Then, the ink I is delivered to the supply-side ink chamber 305 through the ink circulating pump 316 from the collection-side ink chamber 306. After the control unit 510 repeatedly performs the operation and thereby adjusts the amount of the ink of the collection-side ink chamber 306 and the supply-side ink chamber 305 of the ink circulating device 3, the initial filling operation is completed. The ink jet apparatus 1 maintains the airtight state of the ink casing 300 even when the power supply is cut off. Therefore, the meniscus 67 in each of the nozzles 62 is maintained and the ink I does not leak from each of the nozzles 62.

Next, the printing operation will be described. For example, if the printing operation is instructed from a computer, the control unit 510 separates the maintenance unit 71 from the nozzle plate 61. The control unit 510 adjusts the internal pressure of the collection-side ink chamber 306 using the pressure adjustor 303. The control unit 510 drives the ink circulating pump 316 and causes the ink Ito circulate from the collection-side ink chamber 306, the ink circulating pump 316, the supply-side ink chamber 305, the ink jet head 2, and the collection-side ink chamber 306 in this order.

If the ink surfaces a and b detected by the ink level measurement sensors 309A and 309B of the supply-side ink chamber 305 and the collection-side ink chamber 306 does not reach a predetermined level, the control unit 510 drives the ink supply pump 304 and supplies the ink to the supply-side ink chamber 305 from the ink cartridge 41 until the liquid surface of the ink I reaches the predetermined level. The control unit 510 applies a current to the heater 313 bonded to the ink casing 300 and the ink I is heated to reach a predetermined temperature. If the ink I reaches the predetermined temperature, the control unit 510 controls the current supplied to the heater 313 such that the ink temperature is maintained within a predetermined range.

Next, the control unit 510 causes the ink jet head 2 to be synchronized with the scanning of the carriage 51 and causes the ink I to be discharged on the medium S in accordance with image data to be printed. The control unit 510 controls the sliding rail 57 such that the medium S travels a predetermined distance. The control unit 510 repeatedly performs the operation of synchronization with the scanning of the carriage 51 and discharging of the ink I, such that an image is formed on the medium S.

The control unit 510 detects reduction of the internal pressure of the collection-side ink chamber 306 due to discharging of the ink I from the ink jet head 2, using the pressure sensor 310. If the reduction of the internal pressure of the collection-side ink chamber 306 is detected, the control unit 510 drives the pressure adjustor 303, drives the ink supply pump 304, and delivers the ink I corresponding to the amount of the discharged ink to the collection-side ink chamber 306.

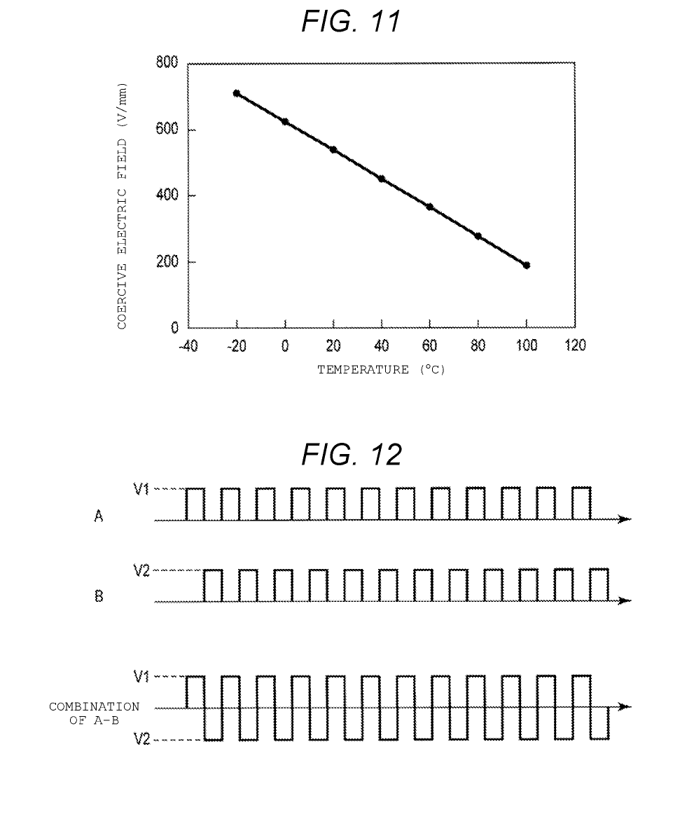

FIG. 11 is a graph showing a relationship between a temperature and a coercive electric field of the PZT mounted on the ink circulating pump 316. The coercive electric field decreases as a temperature of the PZT rises. It is known that piezoelectricity of the PZT gradually deteriorates, if an electric field that exceeds the coercive electric field is applied in a direction in which polarization of the PZT is reversed. In contrast, the PZT does not lose the piezoelectricity even when the electric field that exceeds the coercive electric field is applied in a direction same as the polarization of the PZT. The deterioration of the piezoelectricity of the PZT brings about deterioration of pump performance of the piezoelectric pump.

FIG. 12 is a diagram illustrating, in waveforms, characteristics of a voltage which is applied to the ink circulating pump 316 from the drive circuit 400. A shows a voltage waveform A (voltage V1) to be applied to the wire 336A (refer to FIG. 8). B shows a voltage waveform B (voltage V2) to be applied to the wire 336B (refer to FIG. 8). The combination A-B shows a combined waveform A-B of the voltage waveform A and the voltage waveform B. The voltage waveform A (voltage V1) applies the electric field in the direction in which the polarization of the PZT becomes stronger and the voltage waveform B (voltage V2) applies the electric field in the direction in which the polarization of the PZT is reversed.

In this case, the voltage waveform A and the voltage waveform B have the same height, which indicates that the same voltage is applied in both direction of the PZT.

Next, FIG. 13 is described. In FIG. 13, there is a difference between the voltage of the voltage waveform A (voltage V1) to be applied to the wire 336A (refer to FIG. 8) and the voltage of the voltage waveform B (voltage V2) to be applied to the wire 336B (refer to FIG. 8), respectively. Specifically, the voltage waveform A that causes the electric field in the direction in which the polarization of the PZT becomes stronger has a greater voltage. In contrast, the voltage waveform B that causes the electric field in the direction in which the polarization of the PZT is reversed has a smaller voltage.

According to the present embodiment, two types of voltage is applied to the ink circulating pump 316, i.e., a type of waveform shown in FIG. 12 and a type of waveform shown in FIG. 13, in accordance with an ink temperature.

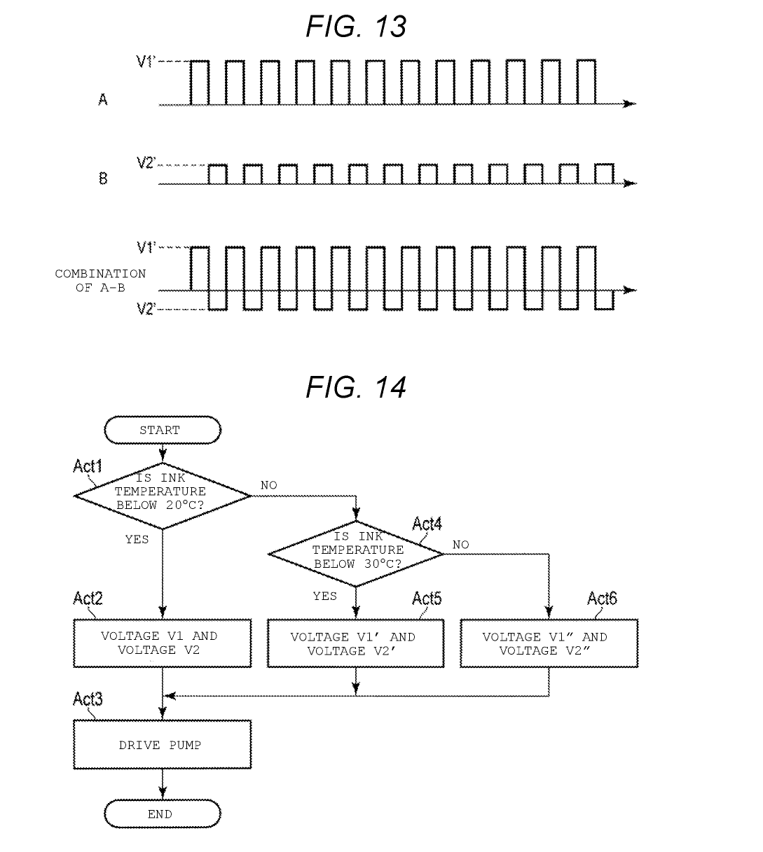

FIG. 14 shows a flowchart of a switching control method of a voltage to be applied to the piezoelectric element in accordance with the ink temperature.

If an ink circulation instruction is transmitted from the control unit 510, the ink circulating device 3 transmits an ink temperature obtained from the ink temperature sensor 314 provided in the ink circulating device 3 to the control unit 510 (Act 1). The control unit 510 determines the ink temperature. If the ink temperature is below 20 degrees, the control unit 510 drives a pump (Act 3) at the voltage V1 and the voltage V2 as the voltages to be applied to the piezoelectric element (Act 2). In addition, if the ink temperature is 20 degrees or higher and lower than 30 degrees (Act 4), the control unit 510 drives the pump (Act 3) at the voltage V1′ and the voltage V2′ as the voltage to be applied to the piezoelectric element (Act 5). In addition, if the ink temperature is 30 degrees or higher, the control unit 510 drives the pump (Act 3) at the voltage V1″ and the voltage V2″ as the voltage to be applied to the piezoelectric element (Act 6).

Specifically, for example, as illustrated in FIG. 15, the voltages V1 and V2, the voltages V1′ and V2′, the voltages V1″ and V2″ are controlled. If the ink temperature is below 20 degrees, the voltages V1 and V2 are the same voltage (150V). Therefore, when the ink temperature read in the ink temperature sensor 314 is in the range of 20 degrees or higher and lower than 30 degrees, the voltage of the voltage waveform B (V2) is switched to V2′ (125 V) so as not to exceed the coercive electric field. In addition, the voltage of the voltage waveform A is switched to V1′ (175 V). A reduced amount of displacement of the piezoelectric vibration plate by switching of V2 to V2′ may be supplemented by switching V1 to V1′. Further, when the ink temperature read in the ink temperature sensor 314 is in the range to 30 degrees or above, the voltage of the voltage waveform B (V2) is switched to V2″ (100 V) so as not to exceed the coercive electric field. In contrast, the voltage of the voltage waveform A is switched to V1″ (200 V). The reduced amount of displacement of the piezoelectric vibration plate by switching of V2 to V2″ may be supplemented by switching of V1 to V1″.

As described above, the voltage waveform A (voltage V1) to be applied to the wire 336A (refer to FIG. 8) and the voltage waveform B (voltage V2) to be applied to the wire 336B (refer to FIG. 8) are controlled in accordance with the ink temperature, whereby deterioration of the ink circulating pump 316 is prevented and it is possible to provide an ink circulating pump 316 in which the reduction of the liquid delivery amount is suppressed as much as possible. The voltage to be applied to the voltages V1 and V2 is appropriately adjusted in accordance by the piezoelectric element or a temperature zone to be used.

If the temperature range is limited or it is difficult to provide a control table as illustrated in FIG. 13, different voltages are used for the voltage waveform A (voltage V1) to be applied to the wire 336A and the voltage waveform B (voltage V2) to be applied to the wire 336B, respectively. Even in this case, the ink circulating pump 316 is prevented from deterioration during a certain rise of the ink temperature and the reduction of the liquid delivery amount may be suppressed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An inkjet apparatus, comprising:
a head configured to discharge liquid through a plurality of nozzles;
a tank includes a first chamber into which the liquid is recovered from the head and a second chamber from which the liquid is supplied to the head;
a circulation unit positioned between the head and the tank and including liquid passages by which the liquid is circulated from the tank to the head and then back to the tank, the circulating unit having a piezoelectric pump unit including an inlet, an outlet, and a chamber formed between the inlet and the outlet, a wall of the chamber including a piezoelectric member;
a heating unit configured to heat the circulated liquid; and
a control unit configured to cause the piezoelectric member to be deformed, by applying voltages to the piezoelectric member.

2. The inkjet apparatus according to claim 1, wherein
the heating unit is disposed on the first chamber.

3. The inkjet apparatus according to claim 1, further comprising:
a temperature detection unit configured to detect a temperature of the circulated liquid.

4. The inkjet apparatus according to claim 3, wherein
the heating unit and the temperature detection unit are disposed on a same wall of the first chamber.

5. The inkjet apparatus according to claim 3, wherein
the control unit is configured to adjust the voltages applied to the piezoelectric member and heat generation by the heating unit, based on the temperature detected by the temperature detection unit.

6. The inkjet apparatus according to claim 5, wherein
the control unit adjusts the voltages applied to the piezoelectric member and the heat generation by the heating unit, such that a flow rate of the liquid is constant.

7. The inkjet apparatus according to claim 1, wherein
the control unit is further configured to control the heating unit, such that a temperature of the circulated liquid becomes a predetermined value.

8. The inkjet apparatus according to claim 1, wherein
the control unit is configured to control the heating unit, such that a viscosity of the circulated liquid becomes a predetermined value.
